(19) United States
(12) Patent Application Publication
(10) Pub. No.: US 2008/0305136 A1
(43) Pub. Date: Dec. 11, 2008

(54) Disinfective adhesive tape

(76) Inventors: Chih-Cheng Yang, Taichung (TW); Chuan-Tao Ko, Fongyuan City (TW)

Correspondence Address: Hershkovitz & Associates, LLC, 2845 Duke Street, Alexandria, VA, 22314, US

(21) Appl. No.: 11/808,007

(22) Filed: Jun. 5, 2007

(51) Int. Cl. A01N 59/16; A01N 25/24

(52) U.S. Cl. 424/407; 424/618

(57) ABSTRACT

A disinfective adhesive tape has a carrier layer, a silver nanoparticle layer and an adhesive layer. The carrier layer has a top surface and a bottom surface. The silver nanoparticle layer is formed on the top surface of the carrier layer and comprises multiple silver nanoparticles. The adhesive layer is applied to the bottom surface of the carrier layer. The disinfective adhesive tape can be applied in any article and act as a disinfectant during daily use.

### BACKGROUND OF THE INVENTION

1. Field of the Invention

The present invention relates to an adhesive tape, and more specifically relates to an adhesive tape with disinfective qualities.

2. Description of the Related Art

Adhesive tape is only used for covering or adhering a surface or object and has an adhesive layer and a carrier layer. However, a conventional adhesive tape cannot be used to sterilize the surface or object the tape covers or adheres to. Adhesive tape with a sterilizing or disinfective qualities is more useful than prior art.

To overcome the shortcomings, the present invention provides an adhesive tape with sterilization function to obviate or mitigate the aforementioned problems.

### SUMMARY OF THE INVENTION

The primary objective of the present invention is to provide a disinfective adhesive tape.

The present invention relates to a disinfective adhesive tape comprising a carrier layer, a silver nanoparticle layer and an adhesive layer. The carrier layer has a top surface and a bottom surface. The silver nanoparticle layer is formed on the top surface of the carrier layer and comprises multiple silver nanoparticles. The adhesive layer is applied to the bottom surface of the carrier layer. The disinfective adhesive tape can be applied to any article and act as a disinfectant during daily use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of adhesive tape in accordance with the present invention; and

FIG. 2 is a cross sectional view in partial section of the adhesive tape in FIG. 1.

### DETAILED DESCRIPTION OF THE INVENTION

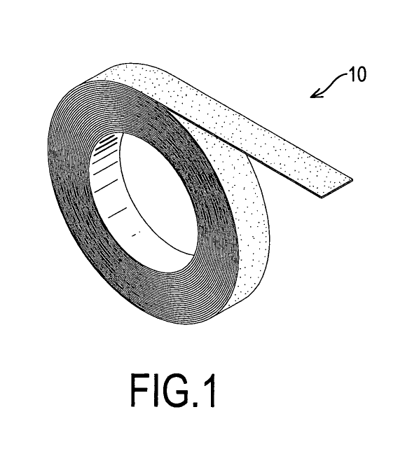

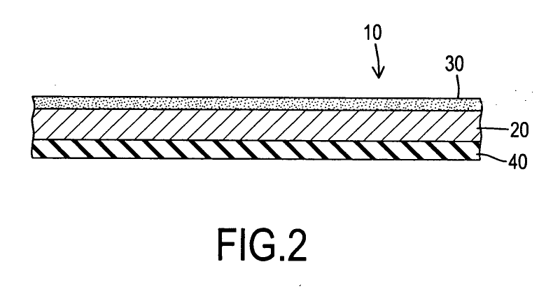

With reference to FIGS. 1 and 2, the present invention relates to a disinfective adhesive tape (10). The disinfective adhesive tape (10) has a carrier layer (20), a silver nanoparticle layer (30) and an adhesive layer (40). The carrier layer (20) may be a non-woven material, a textile material, plastic or such material used as a carrier layer. The carrier layer (20) has a top surface and a bottom surface. The silver nanoparticle layer (30) is formed securely on the top surface of the carrier layer (20) and comprises multiple silver nanoparticles. The adhesive layer (40) is applied to the carrier layer (20). The silver nanoparticle layer (30) may be formed on the carrier layer (20) by silver target sputtering, a technique well understood by a person skilled in the art. In a preferred embodiment, each silver nanoparticle has a diameter of 5 to 10 nanometers. Further, the adhesive layer (40) may be any conventional adhesive layer well understood by a person skilled in the art.

The silver nanoparticles attract oxygen molecules that act as strong oxidants towards microorganisms, without undergoing a light instigated reaction. Further, the silver nanoparticles are able to bind to thiols(groups containing a sulfur-hydrogen bond) of coat proteins of microorganisms, thereby destroying their structure or denaturing the coat protein. These processes effectively kill microorganisms giving the silver nanoparticles a strong disinfective effect.

When a diameter of a nano-sliver particle is between 5 and 10 nanometers, the nanoparticle displays a strong inhibitive effect towards pathogenic E. coli, Staphylococcus spp., molds and viruses. Since the silver nanoparticle is very small, a surface area of any given volume increases as particle size is reduced and the inhibitive and disinfective effects increase.

Furthermore, the adhesive tape (10) has a neutral pH value and is resistant to acidic, basic or salty environments and is stable towards heat and light. Therefore, the disinfective adhesive tape can be used in most environments and retain the strong disinfective effect. Still further, the silver nanoparticles will not degrade with time, so the disinfective adhesive tape (10) proves effective for long term use.

The disinfective adhesive tape (10) in accordance with the present invention may therefore be used in a variety of application, whereby a section of the disinfective adhesive tape (10) is applied to clothes, containers, household appliances, refrigerators, drawers, furniture, aquarium vehicles or such like to provide the long term disinfective effect. Clothes may be underwear, hats, shoes, socks, gauze masks, blanket or curtains. Containers may be cartons, plastic bags, baskets or buckets. Household appliances may be electric fans, filters for air conditioners , kitchenware, or any such article.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A disinfective adhesive tape comprising
a carrier layer having a top surface and a bottom surface;
a silver nanoparticle layer being formed securely on the top surface of the carrier layer and having multiple silver nanoparticles; and
an adhesive layer applied to the bottom surface of the carrier layer.

2. The adhesive tape as claimed in claim 1, wherein the carrier layer is a non-woven material.

3. The adhesive tape as claimed in claim 1, wherein the carrier layer is a plastic.

4. The adhesive tape as claimed in claim 1, wherein the carrier layer is a textile material.
